(19) United States
(12) Patent Application Publication
(10) Pub. No.: US 2009/0018978 A1
(43) Pub. Date: Jan. 15, 2009

(54) Method for Processing Several Flat Packages of a Delivery Customer

(75) Inventor: Andreas Marder, Konstanz (DE)

Correspondence Address: LERNER GREENBERG STEMER LLP, P O BOX 2480, HOLLYWOOD, FL, 33022-2480, US

(73) Assignee: Siemens Aktiengesellschaft, Munich (DE)

(21) Appl. No.: 12/278,190

(22) PCT Filed: Nov. 20, 2006
(86) PCT No.: PCT/EP06/11105

§ 371 Date: Aug. 4, 2008

(30) Foreign Application Priority Data
Feb. 3, 2006 (DE) 10 2006 005 067.3

(51) Int. Cl. G07B 17/00

(52) U.S. Cl. 705/406

(57) ABSTRACT

The amount of work conventionally needed for the delivery and collection of a set of parcels in an automatic delivery station with input of the type of parcel and dispatch, customer and characterizing data and transmission to a billing unit with the release and counting of the parcels for each set with transmission of said data to the billing unit may be reduced by way of the collection of several parcels of the same parcel type and/or dispatch type and the marking of the collected parcels with an unambiguous machine-readable code.

The invention relates to a method for processing a number of flat mail items of one dispatch customer, which are transferred to an automatic receiving station.

In modern mail automation systems there are automatic receiving and collection stations, where parcels, packages and flat mail items, such as letters and large format letters, can be transferred and collected.

Currently the processing process for mail items however takes place in the first instance at the dispatch service, in that the mail items are transferred to dispatch points with receiving and output counters. The mail items are either already franked by the customer or they are franked at the counter. The counter operator hereby sorts the transferred mail items by mail item type, e.g. letters, subdivided by weight, large-format letters, packages and dispatch type, e.g. standard mail item, express mail item, registered mail item. The mail items are then transported to a sorting center, where they are grouped by mail item type and where the stamps are then canceled. The mail items are then sorted automatically according to their destination addresses. The processing of the mail items to dispatch points, in particular in the case of business customers with a large number of mail items, by the operators is relatively time-consuming. The use of automatic receiving stations has not as yet progressed beyond individual field tests.

The object of the invention is to create a method requiring little outlay for processing a number of flat mail items of one dispatch customer, including the transfer of the mail items at the dispatch service.

According to the invention the object is achieved by the features of claim 1.

The following characterizing steps are hereby executed:
grouping a number of mail items of the same mail item type and dispatch type,
transferring and collecting the grouped mail items in the automatic receiving station with inputting of the mail item type and dispatch type, with a dispatch customer thereby being uniquely identified and the identifier being automatically read and being transmitted with the dispatch customer identification and with the inputs to a billing unit and to a stamping unit in an assigned sorting center,
automatic application of the stamps to the individual mail items in the respective sorting center, counting the mail items and transmitting the number of mail items with the identifier to the billing unit,
determining the processing fee for the respectively counted mail items according to the input mail item type and dispatch type and assigning the processing fee to the dispatch customer by way of the identifier (9).

By moving the presorting operation according to mail item type and dispatch type to the dispatch customer/mail item transfer operator on the one hand and the franking process to the mail item presorting operation of the sorting centers on the other hand it is possible to reduce the amount of work hitherto required.

Advantageous embodiments of the invention are set out in the subclaims.

Various options are set out for grouping the mail items. It is thus advantageous to place the mail items in dispatch bags, which are or will be provided with a machine-readable identifier that can be reused in the form of a label. When the dispatch bags are opened and the mail items removed, the frontmost mail item is provided with the reusable label of the respective dispatch bag.

In a further variant the mail items are placed in containers. To undo the grouping, the mail items are removed from the containers, the frontmost mail item being provided with the unique, machine-readable identifier.

It is also possible to bundle the mail items for grouping, for example using rubber bands, the frontmost mail item being provided with the bundle identifier.

It is advantageous if, to implement the further dispatch process, the destination addresses of the mail items are determined and the mail items are then forwarded to the relevant sorting facilities in the sorting center.

To enhance transport reliability, it is advantageous, when the grouped mail items are transferred to the receiving station, if the number of mail items is input and likewise transmitted to the billing unit, with the mail items being counted in the sorting center to validate the number of mail items.

To enhance reliability when determining and assigning the fee, it is also advantageous, after transfer of the grouped mail items to the receiving station, to transmit the transfer date and time to the billing unit.

The invention is described below based on an exemplary embodiment with reference to the drawings, in which:

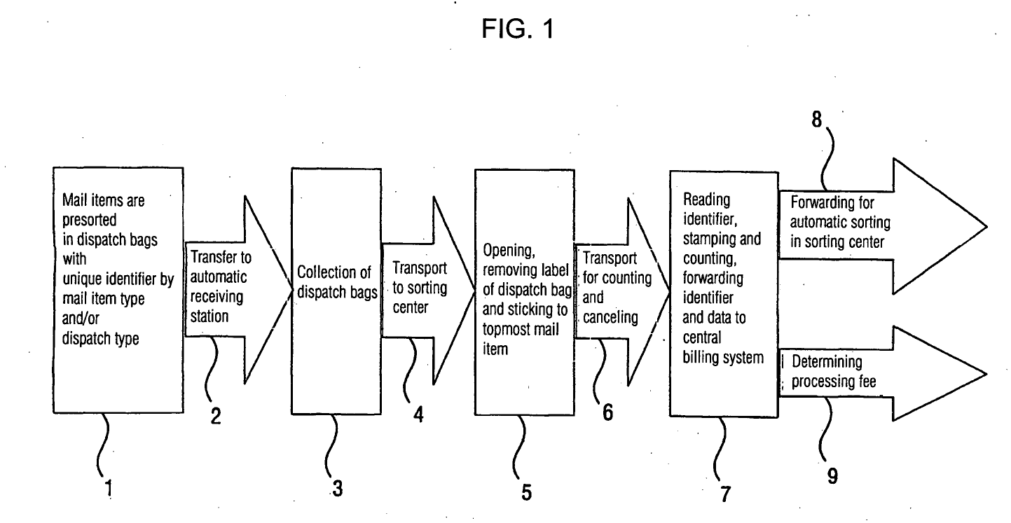

FIG. 1 shows the method sequence using dispatch bags,

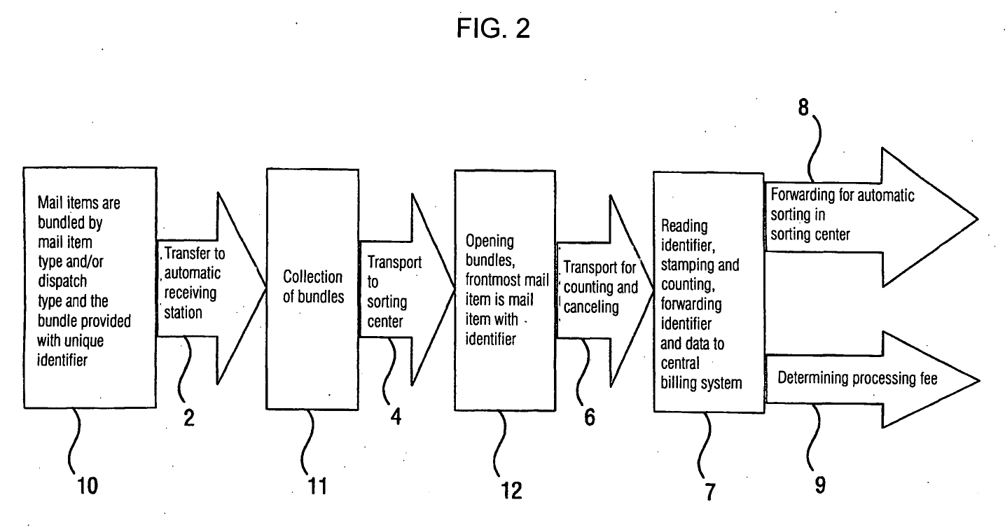

FIG. 2 shows the method sequence with bundled mail items,

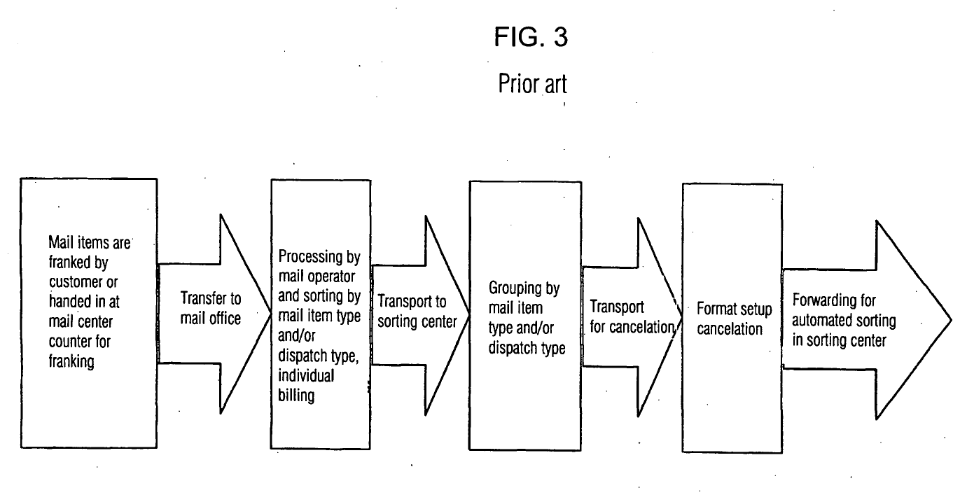

FIG. 3 shows the method sequence according to the prior art.

According to FIG. 1 the dispatch customer groups the mail items by mail item type and/or dispatch type in dispatch bags 1 and transfers these to a receiving station of a mail service 2. After registering at the receiving station using a customer card or credit card, the dispatch bags, each with a unique, machine-readable identifier, e.g. a barcode, are held up to a barcode scanning window of the receiving station, the barcode is scanned and transmitted with the mail item transfer data to a billing unit and stored there in a file. The dispatch bags are provided by the mail service with a machine-readable barcode on a detachable label. As stated above, the mail items must hereby be bagged in dispatch bags, having been sorted by mail item type, e.g. standard letters, letters larger than standard letters, large-format letters (flats) and/or dispatch type (e.g. standard mail, express mail, registered), in other words in the letter types and dispatch types of the various charge bands. A different color dispatch bag can be used for each different type. In the receiving station the dispatch bags are collected 3 and then transported to the assigned sorting center 4. There the dispatch bags are opened, the mail items are removed and the label with the barcode of the dispatch bag is stuck to the frontmost mail item 5. The mail items are hereby aligned by front face and lower edge. The mail items are then transported to what is known as a setting up machine to be counted and stamped 6. To this end the mail items are placed or stacked in containers, with all the mail items of one dispatch customer being stacked in the same container. The mail items of a number of dispatch bags are hereby kept separate by means of the barcode on the first mail item. At the setting up machine the mail items are placed on the feeder bed for stamping, being aligned for a stamping unit. The mail items are then stamped separately, by applying the stamping unit, a camera is used to read the barcode of the dispatch bag on the first mail item and the mail items are counted up to the next mail item with a barcode label. The read identifier data of the label is transmitted together with the number of associated mail items to the billing unit, where the data is assigned to the dispatch customer and charge band for customer billing according to the mailing item type and dispatch type 7. Larger and thicker mail items can be scanned and counted with the aid of manual scanners. Stamping can also take place manually. The mail items are then forwarded to the sorting machines in the sorting center and sorted there by destination addresses 8.

If the mail items are grouped in bundles according to FIG. 2, using rubber bands for example, a label with the machine-readable bundle identifier is applied to the frontmost mail item in the bundle 9. The next steps 2, 10, 4, 11, 6, 7 and 8, which correspond to steps 2 to 8 already described, are then carried out, with the sole difference that there are bundles instead of dispatch bags. It is therefore not necessary to remove the label from a dispatch bag and apply it to the frontmost mail item in the sorting center.

Instead of grouping by bundling, grouping can also be achieved by placing the mail items into an open container. The identifier is then likewise located on the frontmost mail item.

1-7. (canceled)

8. A method of processing a plurality of flat mail items of a dispatch customer, which comprises:
receiving and collecting a plurality of mail items in an automatic receiving station from a dispatch customer, grouping the plurality of mail items of a common mail item type and dispatch type, inputting a mail item type and dispatch type to thereby uniquely identify the dispatch customer, and marking the grouped mail items with a unique, machine-readable identifier;
automatically reading the identifier and transmitting the identifier together with the dispatch customer identification and the input to a billing unit and to a stamping unit in an associated sorting center, transporting the grouped mail items to a sorting center, undoing the grouping of the mail items in the sorting center, and automatically reading the identifier of the grouped mail items a second time;
automatically franking the individual mail items in the sorting center, counting the mail items and transmitting a number of counted mail items with the identifier to a billing unit; and
determining a processing fee for the respectively counted mail items according to the input mail item type and dispatch type and charging the processing fee to the dispatch customer by way of the identifier.

9. The method according to claim 8, wherein the step of grouping the mail items comprises placing the mail items in dispatch bags, the dispatch bags being provided with a machine-readable identifier configured to be reused in the form of a label with the frontmost mail item being provided with the reusable label of the respective dispatch bag when the dispatch bags are opened and the mail items removed.

10. The method according to claim 8, wherein the step of grouping the mail items comprises placing the mail items in containers and the step of undoing the mail items comprises removing the mail items from the containers, wherein a frontmost mail item is provided with the unique, machine-readable identifier.

11. The method according to claim 8, wherein the step of grouping the mail items comprises bundling the mail items and providing a frontmost mail item with a bundle identifier.

12. The method according to claim 8, which comprises determining destination addresses of the mail items and forwarding the mail items to relevant sorting facilities in the sorting center.

13. The method according to claim 8, which comprises transferring the grouped mail items to the receiving station and thereby inputting a number of mail items, transmitting the number of mail items to the billing unit together with the number of mail items counted in the sorting center, to thereby validate the number of mail items.

14. The method according to claim 8, which comprises, after the grouped mail items have been transferred to the receiving station, transmitting a transfer date and transfer time to the billing unit.
